(19) United States
(12) Patent Application Publication
(10) Pub. No.: US 2012/0073892 A1
(43) Pub. Date: Mar. 29, 2012

(54) IGNITION INTERLOCK AND DRIVING MONITORING SYSTEM AND METHOD

(76) Inventor: Cecil L. Hunter, Apopka, FL (US)

(21) Appl. No.: 12/889,491

(22) Filed: Sep. 24, 2010

(51) Int. Cl. B60K 28/06; B60K 28/04

(52) U.S. Cl. 180/273

(57) ABSTRACT

An ignition interlock and driving monitoring system having multiple sensors connected to a central processor (1) that monitors a vehicle operator for the presence of alcohol in the vehicle operator's system using one or more alcohol sensors (3), such as a transdermal sensor (4) located on a vehicle's steering wheel or a breathalyzer (5). A weight sensor (6) and/or a seat belt sensor (7) monitors the presence of the vehicle operator inside the vehicle to prevent an intoxicated individual from circumventing the system. If at any time the central processor receives a reading from one of the sensors that the vehicle operator is intoxicated or has committed a traffic infraction, then authorities are notified through a wireless notification, such as a message communicated through cellular, satellite, or other wireless technology.

### BACKGROUND OF THE INVENTION

This invention relates to alcohol ignition interlock devices for motor vehicles, more particularly, an ignition interlock and driving monitoring system having multiple sensors that monitor a vehicle operator for the presence of alcohol in the vehicle operator's system, monitor the operation of the vehicle and monitor the presence of the vehicle operator inside the vehicle.

Drunk driving is the cause of many injuries and deaths. Many states have imposed requirements for interlocking devices for motor vehicles that are operated by those who have been arrested or convicted of driving under the influence of alcohol. These systems typically require the vehicle operator to take a breath test by blowing into a mouthpiece installed in the car. The mouth piece measures the amount of alcohol in the vehicle operator's breath and uses that measurement to determine the vehicle operator's blood alcohol content (“BAC”). Other systems use transdermal detection devices to determine the vehicle operator's BAC through the vehicle operator's skin. However, these systems can be bypassed by having someone who is sober take the test to activate the car ignition system for the drunk driver. Conventional systems also fail to monitor for traffic infractions and to notify authorities of such traffic infractions and/or an individual attempting to operate a vehicle while intoxicated.

Therefore, a need exists for a monitoring system that monitors a vehicle operator for the presence of alcohol in the vehicle operator's system, monitors the driving habits of the vehicle operator, monitors the presence of the vehicle operator inside the vehicle, and a system that will notify authorities of drunk driving and/or traffic infractions.

The relevant prior art includes the following patent references:

| | | | |
|---|---|---|---|
| 2008/0316037 | Shoji et al. | Dec. | 25, 2008 |
| 7,413,047 | Brown et al. | Aug. | 19, 2008 |
| 7,299,890 | Mobley et al. | Nov. | 27, 2007 |
| 7,236,094 | Jones | Jun. | 26, 2007 |
| 7,173,536 | Duval | Feb. | 06, 2007 |
| 2006/0253711 | Kallman | Nov. | 09, 2006 |
| 6,886,653 | Bellehumeur | May | 03, 2005 |
| 6,819,248 | Gotfried | Nov. | 16, 2004 |
| 2004/00830131 | Okezie | Apr. | 29, 2004 |
| GB2392201 | Weir | Feb. | 25, 2004 |
| 6,229,908 | Edmonds, III et al. | May | 08, 2001 |
| 6,075,444 | Sohege et al. | Jun. | 13, 2000 |
| 5,969,615 | Ivey, Jr. et al. | Oct. | 19, 1999 |
| 5,793,292 | Ivey, Jr. | Aug. | 11, 1998 |
| 5,743,349 | Steinberg | Apr. | 28, 1998 |
| 4,706,072 | Ikeyama | Nov. | 10, 1987 |
| 4,613,845 | Du Bois | Sep. | 23, 1986 |
| 3,831,707 | Takeuchi | Aug. | 27, 1974 |

### SUMMARY OF THE INVENTION

The primary object of the present invention is to provide an ignition interlock and driving monitoring system and method that monitors for the presence of alcohol in a vehicle operator's system.

An even further object of the present invention is to provide an ignition interlock and driving monitoring system and method that prevents an intoxicated vehicle operator from circumventing the system by preventing any sober individual from starting the vehicle and then switching places with the intoxicated vehicle operator.

Another object of the present invention is to provide an ignition interlock and driving monitoring system and method that stores information such as a vehicle operator's driving history and/or vehicle information.

An even further object of the present invention is to provide an ignition interlock and driving monitoring system and method that sends wireless alerts to third parties that an intoxicated individual is attempting to operate the vehicle and/or that a traffic infraction has occurred.

The present invention fulfills the above and other objects by providing a system having multiple sensors connected to a central processing unit that monitor a vehicle operator for the presence of alcohol in the vehicle operator's system, monitor the operation of the vehicle and monitor the presence of the vehicle operator inside the vehicle. One or more alcohol sensors, such as a transdermal sensor and/or a breathalyzer, are connected to the central processor. The transdermal sensor is preferably located on a steering wheel of the vehicle so that a vehicle operator's hands are in constant contact with the transdermal sensor while driving. The transdermal sensor monitors for the presence of alcohol present in a vehicle operator's perspiration that is constantly produced and given off by the vehicle operator's skin. A breath sensor or breathalyzer monitors the concentration of alcohol present in a vehicle operator's breath. A weight sensor is preferably located in the vehicle operator's seat of the vehicle to detect and monitor the presence of a vehicle operator in the vehicle operator's seat. A seat belt monitor detects and monitors if the vehicle operator is wearing his or her seatbelt. If the weight monitor and seat belt monitor detect that the vehicle operator has exited the vehicle, then the system will be deactivated ant the ignition of the vehicle will be locked. This ensures that an intoxicated individual cannot circumvent the system by having a sober individual attempt to start the vehicle and then switch places with the intoxicated individual. A vehicle operator identification device is also connected to the central processor. The vehicle operator identification device may be a keypad that requires the vehicle operator to enter in a pin number that is personal to the vehicle operator. The vehicle operator identification device may also be an electronic swipe that requires the vehicle operator to swipe the magnetic strip of his or her driver's license. The central processor controls the ignition of the vehicle and depending on the readings from the various sensors, the central processor will either prevent the ignition from being started or allow the ignition to be started. A global positioning system monitor (“GPS”) connected to the central processor monitors the geographic location of the vehicle. A memory for storing a driving history of one or vehicle operators and/or the vehicle history is connected to the central processor. The memory may store speeds of the vehicle measured by the vehicle's speedometer and store that information along with coordinates from the GPS. Information may be entered or retrieved from the memory and/or central processor through a manual input. For example, police could access the memory and central processor to obtain a vehicle's driving history or a vehicle operator's personal driving history. If at any time the central processor receives a reading from one of the sensors that the vehicle operator is intoxicated then authorities are notified through a wireless notification means, such as a message communicated through cellular, satellite, or other wireless technology. The ignition interlock and driving monitoring system and method may be used on any vehicle, such as automobiles, boats, airplanes, etc.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a block diagram of an ignition interlock and driving monitoring system of the present invention;

FIG. 2 is a flow chart of an ignition interlock and driving monitoring system and method of the present invention;

FIG. 3 is a flow chart of an ignition interlock and driving monitoring system and method of the present invention showing the steps taken by the system if a alcohol is detected while a vehicle is being operated;

FIG. 4 is a flow chart of an ignition interlock and driving monitoring system and method of the present invention showing the steps for monitoring traffic infractions;

FIG. 5 is a flow chart of an ignition interlock and driving monitoring system and method of the present invention showing a system override;

FIG. 6 is a flow chart of an ignition interlock and driving monitoring system and method of the present invention showing steps for updating predetermined levels in the system; and

FIG. 7 is a flow chart of an ignition interlock and driving monitoring system and method of the present invention showing the steps taken if the system becomes inoperable.

### DESCRIPTION OF THE PREFERRED EMBODIMENTS

For purposes of describing the preferred embodiment, the terminology used in reference to the numbered components in the drawings is as follows:

| | |
|---|---|
| 1. | central processor |
| 2. | power source |
| 3. | alcohol sensor |
| 4. | transdermal sensor |
| 5. | breathalyzer |
| 6. | weight sensor |
| 7. | seat belt sensor |
| 8. | vehicle operator identification device |
| 9. | ignition |
| 10. | global positioning system monitor (GPS) |
| 11. | memory |
| 12. | speedometer |
| 13. | manual input |
| 14. | notification means |
| 15. | vehicle operator enters vehicle |
| 16. | place key in ignition |
| 17. | enter identifying information |
| 18. | weight sensor detects presence of vehicle operator |
| 19. | seat belt sensor detects secured seat belt |
| 20. | alcohol sensor detects for alcohol |
| 21. | alcohol exceeds predetermined limit |
| 22. | ignition remains locked |
| 23. | system sends wireless alert |
| 24. | alcohol does not exceed predetermined limit |
| 25. | ignition is unlocked |
| 26. | sensors continue to detect presence of vehicle operator |
| 27. | vehicle operator remains present in vehicle |
| 28. | ignition remains unlocked & vehicle continues to run |
| 29. | vehicle operator's presence is not detected |
| 30. | ignition locked and vehicle disabled |
| 31. | alcohol sensors continue to monitor for presence of alcohol |
| 32. | alcohol exceeds predetermined limit |
| 33. | ignition locked and vehicle disabled |
| 34. | system sends wireless alert |
| 35. | alcohol does not exceed predetermined limit |
| 36. | ignition remains unlocked & vehicle continues to run |
| 37. | system monitors for driving infractions |
| 38. | infraction detected |
| 39. | system sends wireless alert |
| 40. | vehicle is operated |
| 41. | alcohol sensor detects for alcohol |
| 42. | alcohol does not exceed predetermined limit |
| 43. | ignition remains unlocked & vehicle continues to run |
| 44. | alcohol exceeds predetermined limit |
| 45. | system sends wireless alert |
| 46. | speed of vehicle is decreased |
| 47. | hazard lights activated |
| 48. | traffic infraction detected |
| 49. | traffic infraction is minor |
| 50. | store in memory for predetermined amount of time |
| 51. | traffic infraction is major |
| 52. | system sends wireless alert |
| 53. | driver enters vehicle |
| 54. | override means is used |
| 55. | ignition is unlocked |
| 56. | GPS determines location of vehicle |
| 57. | predetermined limits are adjusted |
| 58. | system becomes inoperable |
| 59. | wireless alert sent |
| 60. | vehicle operator given predetermined amount of time |

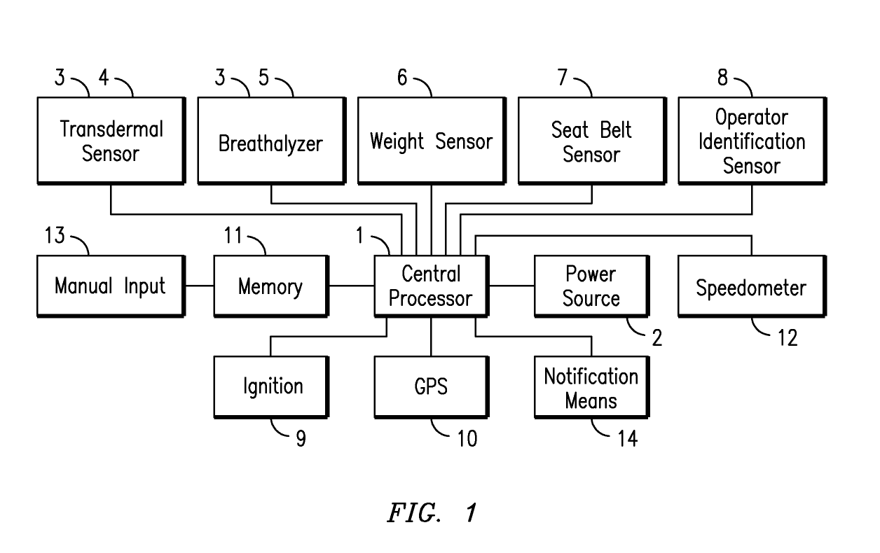

With reference to FIG. 1, a block diagram of an ignition interlock and driving monitoring system and method of the present invention is shown. The system comprises multiple sensors connected to a central processing unit 1 that is connected to a power source 2, such as a vehicle's battery. One or more alcohol sensors 3, such as a transdermal sensor 4 or a breathalyzer 5, are connected to the central processor 1. The transdermal sensor 4 is preferably located on a steering wheel of the vehicle so that a vehicle operator's hands are in constant contact with the transdermal sensor 4 while driving. The transdermal sensor 4 monitors for the presence of alcohol present in a vehicle operator's perspiration that is constantly produced and given off by the vehicle operator's skin. A breath sensor or breathalyzer 5 monitors the concentration of alcohol present in a vehicle operator's breath. A weight sensor 6 is preferably located in the vehicle operator's seat of the vehicle to detect and monitor the presence of a vehicle operator in the vehicle operator's seat. A seat belt monitor 7 detects and monitors if the vehicle operator is wearing his or her seatbelt. A vehicle operator identification device 8 is also connected to the central processor 1. The vehicle operator identification device 8 may be a keypad that requires a vehicle operator to enter in a personal identification number (“PIN”) that is personal to the vehicle operator and/or an electronic swipe that requires the vehicle operator to swipe the magnetic strip of his or her vehicle operator's license. The central processor 1 controls the ignition 9 of the vehicle and depending on the readings from the various sensors the central processor 1 will either prevent the ignition 9 from being started or allow the ignition 9 to be started. A global positioning system monitor (GPS) 10 connected to the central processor 1 monitors the geographic location of the vehicle. A memory 11 for storing a driving history of one or more vehicle operators and/or the vehicle history is connected to the central processor 1. The memory 11 may store speeds of the vehicle measured by the vehicle's speedometer 12 and store that information in the history along with coordinates from the GPS 10. Information may be entered or retrieved from the memory 11 and/or central processor 1 through a manual input 13. If at any time the central processor 1 receives a reading from one of the sensors that the vehicle operator is intoxicated then authorities are notified through a wireless notification means 14, such as a message communicated through cellular, satellite, or other wireless technology.

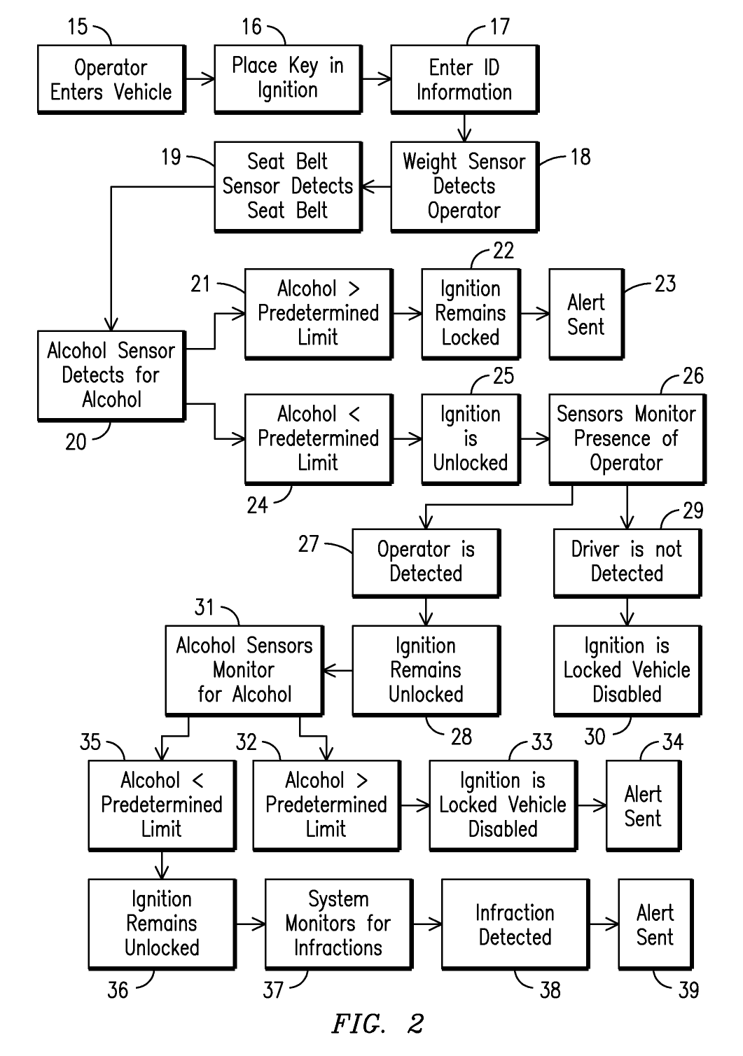

With reference to FIG. 2, a flow chart of an ignition interlock and driving monitoring system and method of the present invention is shown. First, a vehicle operator first enters a vehicle and sits in the vehicle operator's seat 15. Then, the vehicle operator places a key in the ignition of the vehicle 16 which activates the system by providing electricity to the system from the power source 2, as shown in FIG. 1. Next, the vehicle operator enters identifying information into a vehicle operator identification device, such as a keypad that requires a vehicle operator to enter in a PIN number that is personal to the vehicle operator and/or an electronic swipe that requires the vehicle operator to swipe the magnetic strip of his or her driver's license 17. Then, one or more weight sensors located in the vehicle operator's seat detect that an individual is sitting in the vehicle operator's seat and takes a reading of the vehicle operator's weight 18. Next, a seat belt sensor detects whether or not the vehicle operator has properly secured himself or herself into the vehicle operator's seat 19. Then, an alcohol sensor takes a reading of the vehicle operator's BAC 20. The alcohol sensor may be a transdermal sensor 4, preferably located on the steering wheel of the vehicle, and/or a breathalyzer 5, as shown in FIG. 1.

If the alcohol sensor detects alcohol or a BAC that exceeds a set predetermined limit 21, then the system will not allow the vehicle operator to start the ignition of the vehicle 22. The system may also send a wireless alert to authorities that an intoxicated individual has attempted to operate the vehicle 23. The alert may include the identification of the vehicle operator, vehicle information and/or the geographic location of the vehicle.

If the alcohol sensor does not detect alcohol or a BAC that exceeds a set predetermined limit 24, then the vehicle operator is allowed to start the ignition and the vehicle 25. The one or more weight sensors and the seat belt sensor continue to monitor the presence of the vehicle operator in the vehicle operator's seat 26. If the one or more weight sensors and/or the seat belt sensor continue to detect the presence of the vehicle operator in the vehicle operator's seat 27, then the vehicle will remain running 28. If the one or more weight sensors and/or the seat belt sensor detect that the vehicle operator has exited the vehicle 29, then the system will turn the ignition and the vehicle off and the vehicle operator will be required to restart the entire system 30.

While the vehicle is being operated, the alcohol sensors continuously or randomly monitor for the presence of alcohol in the vehicle operator 31. For example, the transdermal sensors can constantly monitor the vehicle operator's BAC through the palms of his or her hands and/or randomly alert the vehicle operator that he or she must place his or her hands on the transdermal sensors and/or blow into a breathalyzer. If an alcohol sensor detects alcohol or a BAC that exceeds a set predetermined limit 32, then the system will shut the vehicle down 33. The system may also send a wireless alert to authorities that an intoxicated individual has been operating the vehicle 34. The alert may include the identification of the vehicle operator, the vehicle operator's driving history, vehicle information and/or the geographic location of the vehicle. If an alcohol sensor does not detect alcohol or a BAC that exceeds a set predetermined limit 35, then the ignition will remain unlocked and the vehicle will continue to run 36. While the vehicle is in operation, the system monitors for driving infractions 35. If the system detects a driving infraction 36, such as speeding, running a red light, etc., then the system will send a wireless alert to authorities 37. The alert may include the identification of the vehicle operator, the vehicle operator's driving history, vehicle information and/or the geographic location of the vehicle.

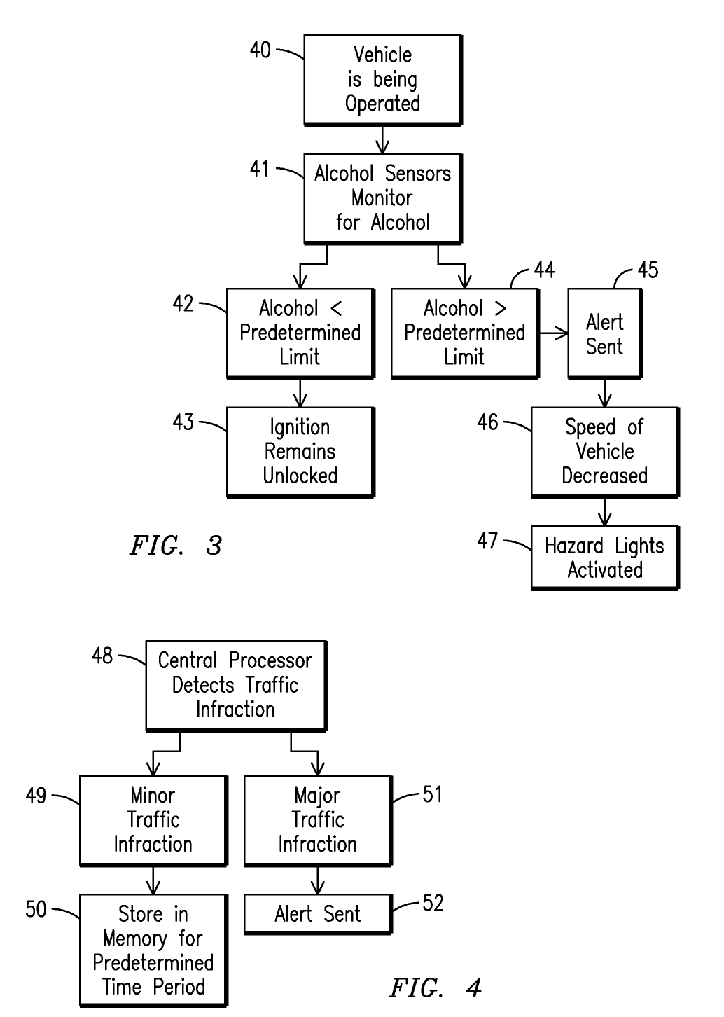

With reference to FIG. 3, a flow chart of an ignition interlock and driving monitoring system and method of the present invention showing the steps taken by the system if a alcohol is detected while a vehicle is being operated is shown. First the operator goes through the steps shown in FIG. 2 to unlock the vehicle's ignition and start the vehicle 40. Then the system continuously and/or randomly monitors for alcohol 41. If an alcohol sensor does not detect alcohol or a BAC that exceeds a set predetermined limit 42, then the ignition will remain unlocked and the vehicle will continue to run 43. However, if an alcohol sensor detects alcohol or a BAC that exceeds a set predetermined limit 44, then the system will send an alert to authorities 45. Then the system will decrease the speed of the vehicle to a predetermined speed 46 and will activate the vehicle's hazard lights 47.

With reference to FIG. 4, a flow chart of an ignition interlock and driving monitoring system method of the present invention showing the steps for monitoring traffic infractions is shown. First, the central processor detects a traffic infraction 48. If the traffic infraction is a minor infraction 49, then the infraction is stored in the memory for a predetermined amount of time 50. However, if the traffic infraction is a major infraction or an accident is sensed 51, then a wireless alert is sent to authorities 52.

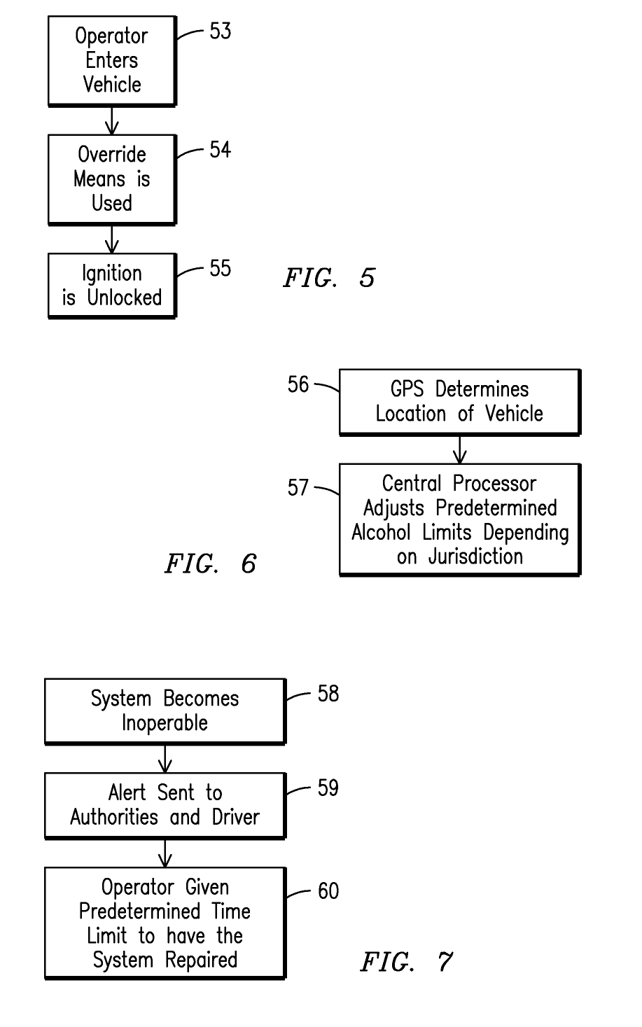

With reference to FIG. 5, a flow chart of an ignition interlock and driving monitoring system and method of the present invention showing a system override is shown. In cases of emergencies, a system override is provided to allow an operator to bypass the system and start a vehicle. First, the driver enters the vehicle 53. Then, the driver uses an override means, such as a magnetic wand, a card having a magnetic strip, or a pin number, that may be entered into the driver identification sensor 54, which then unlocks the ignition 55.

With reference to FIG. 6, a flow chart of an ignition interlock and driving monitoring system and method of the present invention showing steps for updating predetermined levels in the system is shown. While a vehicle is being operated the GPS determines the location of the vehicle and sends the location the central processor 56. The central processor then adjusts predetermined levels of BAC, speed limits, authorities who are to receive wireless alerts, etc. depending on the jurisdiction the vehicle is located in 57.

Finally with reference to FIG. 7, a flow chart of an ignition interlock and driving monitoring system and method of the present invention showing the steps taken if the system becomes inoperable is shown. If the system becomes inoperable 58, then a wireless alert is sent to the authorities 59 and the vehicle operator is alerted to a predetermined amount of time in which the system must be repaired 60.

It is to be understood that while a preferred embodiment of the invention is illustrated, it is not to be limited to the specific form or arrangement of parts or use herein described and shown. It will be apparent to those skilled in the art that various changes may be made without departing from the scope of the invention and the invention is not to be considered limited to what is shown and described in the specification and drawings.

Having thus described my invention, I claim:

1. A vehicle ignition interlock and driving monitoring system comprising:
a central processor;
a power source connected to the central processor;
at least one alcohol sensor connected to the central processor for measuring and monitoring the presence of alcohol in a vehicle operator;
a weight sensor connected to the central processor for monitoring and detecting the presence of the vehicle operator; and
said central processor is connected to an ignition of the vehicle.

2. The vehicle ignition interlock and driving monitoring system of claim 1 further comprising:
a seat belt sensor connected to the central processor for monitoring and detecting that the vehicle operator is wearing his or her seatbelt.

3. The vehicle ignition interlock and driving monitoring system of claim 1 further comprising:
a vehicle operator identification device connected to the central processor.

4. The vehicle ignition interlock and driving monitoring system of claim 3 wherein:
said vehicle operator identification device is a keypad that allows the vehicle operator to enter a pin.

5. The vehicle ignition interlock and driving monitoring system of claim 3 wherein:
said vehicle operator identification device is an electronic swipe for reading a magnetic strip from a group of identification cards including a driver's license.

6. The vehicle ignition interlock and driving monitoring system of claim 1 wherein:
said alcohol sensor is a transdermal sensor located on a steering wheel of the vehicle.

7. The vehicle ignition interlock and driving monitoring system of claim 1 wherein:
said alcohol sensor is a breathalyzer.

8. The vehicle ignition interlock and driving monitoring system of claim 1 wherein:
said central processor is connected to the speedometer of the vehicle for monitoring the speed of the vehicle.

9. The vehicle ignition interlock and driving monitoring system of claim 1 further comprising:
a notification means connected to said processor for sending alerts from the central processor to third parties.

10. The vehicle ignition interlock and driving monitoring system of claim 1 further comprising:
a global positioning system connected to the central processor for determining the geographic location of the vehicle.

11. The vehicle ignition interlock and driving monitoring system of claim 1 further comprising:
a memory connected to the central processor for storing information from the central processor.

12. The vehicle ignition interlock and driving monitoring system of claim 11 further comprising:
a manual input for entering and storing information onto the memory.

13. A method of preventing drunk driving and monitoring the operation of a vehicle using an ignition interlock and driving monitoring system comprising a central processor connected to an ignition of the vehicle, a power source connected to the central processor, at least one alcohol sensor connected to the central processor for measuring and monitoring the presence of alcohol in a vehicle operator and a weight sensor connected to the central processor for monitoring and detecting the presence of the vehicle operator said method comprising the steps of:
a. a vehicle operator entering a vehicle;
b. the vehicle operator placing a key in an ignition of the vehicle;
c. the weight detecting sensor monitoring the continued presence of the vehicle operator in the vehicle;
d. the at least one alcohol sensor testing for the presence of alcohol in the vehicle operator;
e. the at least one alcohol sensor sending a result of the test to the central processor; and
f. the central processor using the result of the test to determine whether or not to allow operator of the vehicle to start the ignition of the vehicle.

14. The method of claim 13 wherein:
said at least one alcohol sensor is a transdermal sensor.

15. The method of claim 13 wherein:
said at least one alcohol sensor is a breathalyzer.

16. The method of claim 13 further comprising a step after a of:
the vehicle operator entering information into a vehicle operator identification device connected to the central processor.

17. The method of claim 16 wherein:
the vehicle operator identification device is a keypad that allows the vehicle operator to enter a pin.

18. The method of claim 16 wherein:
the vehicle operator identification device is an electronic swipe for reading a magnetic strip of a driver's license or other identification card.

19. The method of claim 13 further comprising a step after b of:
a seat belt sensor connected to the central processor monitoring and detecting that the vehicle operator is wearing his or her seatbelt.

20. The method of claim 13 further comprising a step after f of:
the central processor sending a wireless alert to a third party.

21. The method of claim 13 further comprising steps after f of:
the weight detecting sensor sending a signal to the central processor that the vehicle operator has exited the vehicle; and
the central processor locking the ignition.

22. The method of claim 19 further comprising steps after f of:
the seat belt sensor sending a signal to the central processor that the vehicle operator has exited the vehicle; and
the central processor locking the ignition.

23. The method of claim 13 further comprising steps after f of:
said at least one alcohol sensor continuing to test for the presence of alcohol in the vehicle operator;
the at least one alcohol sensor sending a result of the test to a central processor; and
the central processor using the result of the test to determine whether or not to allow the vehicle operator continue to operate the vehicle.

24. The method of claim 23 further comprising steps of:
the central processor determined the vehicle operator should not be operating the vehicle;
the central processor sending a wireless alert; and
the central processor decreasing speed of the vehicle to a predetermined speed.

25. The method of claim 24 further comprising steps of:
the central processor activating hazard lights.

26. The method of claim 13 further comprising steps after f of:
of the central processor monitoring for the vehicle operator committing a traffic infraction; and
the central processor sending a wireless alert to a third party when a traffic infraction is committed.

27. The method of claim 13 further comprising steps after f of:
the central processor monitoring for the vehicle operator committing a traffic infraction; and
the central processor storing the traffic infraction in a memory.

28. The method of claim 13 further comprising a step after f of the central processor sending a geographic location of the vehicle to a third party via a wireless alert.

29. The method of claim 13 further comprising the step of:
storing information in a memory connected to the central processor.

29. The method of claim 13 further comprising the step after b of:
using an override means to unlock the ignition.

30. The method of claim 13 further comprising the steps of:
determining the location of the vehicle; and
updating parameters based on the location of the vehicle.

31. The method of claim 13 further comprising the steps of:
the system becoming inoperable;
a wireless alert being sent; and
the vehicle operator being given a predetermined amount of time to repair the system.

32. A system for preventing drunk driving and monitoring the operation of a vehicle using a, ignition interlock and driving monitoring system comprising a central processor connected to an ignition of the vehicle, a power source connected to the central processor, at least one alcohol sensor connected to the central processor for measuring and monitoring the presence of alcohol in a vehicle operator and a weight sensor connected to the central processor for monitoring and detecting the presence of the vehicle operator, said system comprising the elements of:
a vehicle operator entering a vehicle;
the vehicle operator placing a key in an ignition of the vehicle;
the weight sensor monitoring the continued presence of the vehicle operator in the vehicle;
the at least one alcohol sensor testing for the presence of alcohol in the vehicle operator;
the at least one alcohol sensor sending a result of the test to a central processor; and
the central processor using the result of the test to determine whether or not to allow the vehicle operator of the vehicle to start the ignition of the vehicle.

33. The system of claim 32 wherein:
said at least one alcohol sensor is a transdermal sensor.

34. The system of claim 32 wherein:
said at least one alcohol sensor is a breathalyzer.

35. The system of claim 32 further comprising an element of:
the vehicle operator entering information into a vehicle operator identification device connected to the central processor.

36. The system of claim 35 wherein:
the vehicle operator identification device is a keypad that allows the vehicle operator to enter a pin.

37. The system of claim 35 wherein:
the vehicle operator identification device is an electronic swipe for reading a magnetic strip from a group of identification cards including a driver's license.

38. The system of claim 32 further comprising:
a seat belt sensor connected to the central processor for monitoring and detecting that the vehicle operator is wearing his or her seatbelt.

39. The system of claim 32 wherein:
the central processor has a capacity to send a wireless alert to a third party.

40. The system of claim 32 wherein:
the weight detecting sensor has a capacity to send a signal to the central processor that the vehicle operator has exited the vehicle; and
the central processor can lock the ignition.

41. The system of claim 38 wherein:
the seat belt sensor has a capacity to send a signal to the central processor that the vehicle operator has exited the vehicle; and
the central processor can lock the ignition.

42. The system of claim 32 wherein:
said at least one alcohol sensor has a capacity to continue to test for the presence of alcohol in the vehicle operator;
the at least one alcohol sensor can send a result of the test to a central processor; and
the central processor can use the result of the test to determine whether or not to allow operator of the vehicle to start the ignition of the vehicle.

43. The system of claim 42 wherein:
the central processor determines the vehicle operator should not be operating the vehicle;
the central processor can sends a wireless alert; and
the central processor can decrease speed of the vehicle to a predetermined speed.

44. The system of claim 43 wherein:
the central processor is capable of activating hazard lights.

45. The system of claim 32 wherein:
the central processor monitor for the vehicle operator committing a traffic infraction; and
the central processor storing the traffic infraction in a memory.

46. The system of claim 32 wherein:
the central processor has a capacity to monitor for the vehicle operator committing a traffic infraction; and
the central processor can send a wireless alert to a third party when a traffic infraction is committed.

47. The system of claim 32 wherein:
the central processor has a capacity to send a geographic location of the vehicle to a third party via a wireless alert.

48. The system of claim 32 further comprising:
a memory connected to the central processor for storing information.

49. The system of claim 32 wherein:
override means is capable of unlocking the ignition.

50. The system of claim 32 wherein:
a global positioning system can determine the location of the vehicle; and
the central processor is capable of updating parameters based on the location of the vehicle.

51. The system of claim 32 wherein:
the central processor is capable of sending a wireless alert that the system is inoperable.
